(19) United States
(12) Patent Application Publication
(10) Pub. No.: US 2004/0212304 A1
(43) Pub. Date: Oct. 28, 2004

(54) Display panel structure

(75) Inventors: Yueh-Hsiang Hsu, TaoYuan (TW); Chien-Shu Lai, TaoYuan (TW); Ta-Wang Lai, TaoYuan (TW)

Correspondence Address: BRUCE H. TROXELL, SUITE 1404, 5205 LEESBURG PIKE, FALLS CHURCH, VA, 22041, US

(73) Assignee: Optimax Technology Corporation

(21) Appl. No.: 10/624,480

(22) Filed: Jul. 23, 2003

(30) Foreign Application Priority Data
Apr. 25, 2003 (TW) 92206952

(51) Int. Cl. H01J 17/49

(52) U.S. Cl. 313/582; 313/587

(57) ABSTRACT

A display panel structure, which includes plasma display panel and filter, wherein the plasma display panel further has front glass and rear glass. Through this front glass, the plasma display panel displays images to the outside. The rear glass is corresponding to the front glass and is inter-spaced with the front glass. There is plasma enclosed between the rear glass and the front glass. The filter is directly formed upon the front glass, so the filter may be enforced and supported by the front glass and the original glass layer within the filter may be removed.

### FIELD OF THE INVENTION

The invention relates to a display panel structure, and in particular, to a display panel structure having plasma display panel and filter.

### BACKGROUND OF THE INVENTION

Since plasma TV has the advantages of thin size and high-quality picture, so plasma TV is deemed as a replacing product for future color TV. But, from the viewpoint of manufacturing process, since the manufacturing complexity of plasma TV is high, so it is uneasy to increase its yield, and the market of plasma TV is still majored in business application, but the future growing potential of plasma TV is expected in home electric appliances. Each of Asian manufactures is aggressively devoted into the R&D of plasma TV, including: Japan's Sony, NEC, Sharp, Pioneer, Hitachi, Mitsubishi, South Korea's LG, Samsung, and domestic manufactures, such as: Acer Display, Chunghwa Picture Tube, Sampo, Formosa Plastics, and Vtekdisplay, and so on, all which have established R&D teams to aggressively create the future market of plasma TV.

Plasma TV is mainly comprised of a piece of plasma display panel (abbreviated as PDP), which applies inert gases, that is, plasma (e.g., mixture of Neon gas and Xenon gas) that is sealed between two pieces of glass plates. When electronic discharge is created from outside electric field, the ultraviolet rays converted from the energy, of inert gas, created from electronic discharge will excite fluorescent powders, of red, blue, and green colors, coated upon the glass plates to emit light visible by human eyes, such that a colorful picture is constructed. Therefore, plasma TV has the characteristics of wide viewing angle and quick photoelectric response, so it is a self-lighting display.

In order to make users avoided from the radiation of electromagnetic wave and be comfortable during watching plasma TV, a piece of filter will be disposed in front of plasma display panel where visible lights are emitted. Please refer to FIG. 4, which illustrates a simple structuring diagram for both plasma display panel and filter according to the prior plasma TV. Plasma TV 400 mainly includes front and rear glasses 415, 417, between which there is a plasma display panel 410 having plasma and a filter 420 located in front of the plasma display panel 410. The visible lights created from the plasma, in the plasma display panel 410, excited by electrodes, may penetrates through glass 415 to construct colorful picture and, through filter, these visible lights may be filtered out electromagnetic waves carried by themselves and make their colors be more nature and smooth.

General speaking, the filter 420 in a plasma TV 400 further includes a layer of glass 430, which is mainly to enforce and support the filter 420. Unfortunately, when visible light passes through the front glass 415 and this layer of glass 430, interference will be generated from these layers of glass. Therefore, the filter 420, except for locating in front of the plasma display panel 410, must be also spaced a distance from the front glass 430 to remove the interference, of visible lights, generated by two layers of glass. Generally, the is a 5 mm distance spaced between the filter 420 and the front glass 415.

In the prior plasma TV, a gap existing between the plasma display panel and the filter will cause the thickness of TV to increase and, to manufacture a filter in plasma TV is really a shortcoming. For example, it is uneasy and valuable to obtain the glass in filter and, when plasma TV is collided, the filter will be squeezed to make the glass broken therein, such that it creates a safety problem for plasma TV. Moreover, in the filters that belong to 42 inches and 50 inches plasma TVs, the glass plates respectively have weights of 5 kilograms and 10 kilograms. So, the glass in filter not only has specific thickness for the plasma TV, but also will increase the weight of plasma TV.

Therefore, how to improve the assembling structure for both plasma display panel and filter in prior plasma TV and how to get rid of glass in filter are worth studying.

Accordingly, the invention proposes a display panel structure, which will make plasma TV be thinner, lighter, and cheaper without the safety consideration that the glass in filter will be broken because of collision.

### SUMMARY OF THE INVENTION

The main objective of the invention is to provide a display panel structure. This display panel structure includes plasma display panel and filter. Wherein, the plasma display panel further includes front glass and rear glass. Through the front glass, the plasma display panel displays images to the outside. The rear glass is corresponding to the front glass and is inter-spaced with the front glass. There is plasma enclosed between the rear glass and front glass. As for filter, it is formed directly upon the front glass. Therefore, in this display panel structure, the plasma display panel directly forms the filter, so this display panel structure is indeed a plasma display panel having function of optical filter.

In the preferable embodiment according to the invention, the filter does not include glass layer and, facing the plasma display panel, there sequentially are electromagnetic wave shielding layer, color compensating layer, hardening arrangement layer, and anti-reflecting layer.

The secondary objective of the invention is to provide a plasma TV that applies above-mentioned display panel structure. This plasma TV is cheaper and safer because it has a plasma display panel having above-mentioned function of optical filter.

In summary, the invention proposes a display panel structure that may make plasma TV thinner, lighter, cheaper, and valuable without the safety consideration that the glass in filter will be broken because of collision.

### BRIEF DESCRIPTION OF THE DRAWINGS

In order to make your esteemed members of reviewing committee further recognize and understand the characteristics, objectives, and functions of the present invention, a detailed description in accordance with corresponding drawings are presented as follows.

FIG. 1 shows a simple illustration for the side cross-sectional view of a display panel structure of the preferable embodiment according to the invention.

FIG. 2 shows a simple illustration for the side cross-sectional view of a display panel structure of another preferable embodiment according to the invention.

FIG. 3 shows a simple illustration for the side cross-sectional view of a display panel structure of further another preferable embodiment according to the invention.

FIG. 4 shows a simple structuring diagram for both plasma display panel and filter according to prior plasma TV.

### DETAILED DESCRIPTION OF THE INVENTION

In order to make the prior plasma TV be thinner and get rid of the safety consideration by removing the filter that is arranged in front of plasma display panel and is spaced apart the plasma display panel around 5 mm, a concept for providing a display panel structure is proposed. By directly forming filter upon plasma display panel, it may get rid of a breaking problem, of glass layer provided in filter, easily caused by the gap existing between filter and plasma display panel. Furthermore, forming filter directly upon plasma display panel will facilitate the glass arranged upon the plasma display panel in replacing the glass layer arranged in the filter to support and enforce the filter. Therefore, the invention not only makes plasma TV thinner, but also gets rid of safety problem caused by the gap existing between filter and plasma display panel according to the prior plasma TV; furthermore, the spending cost of glass layer arranged in filter may further be saved.

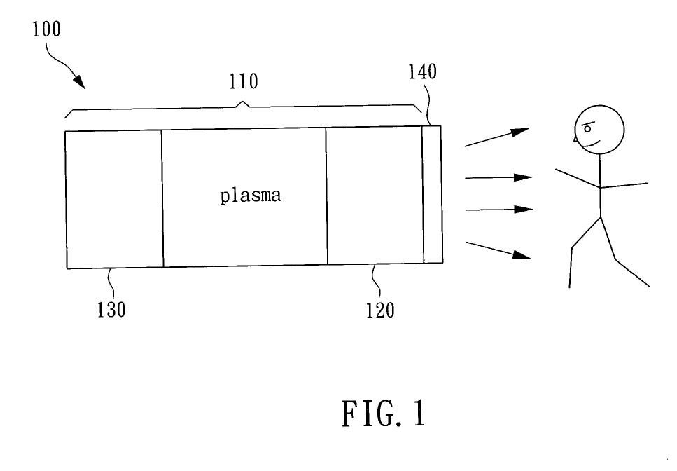

Please refer to FIG. 1, which shows a simple illustration for a side cross-sectional view of the display panel structure of a preferable embodiment according to the present invention. The display panel structure 100 has plasma display panel 110 and filter 140. Wherein, this plasma display panel 110 is comprised of two pieces of glass 120, 130, between which plasma is enclosed. This glass 120 is located at one side where display panel structure 100 displays images to the outside, while glass 130 is located at another side corresponding to glass 120. Wherein, in order to reduce the thickness of this display panel structure, the invention directly forms the filter 140 upon the glass 120, so the display panel structure 100 may make plasma TV thinner.

In another preferable embodiment according to the present invention, not only may the thickness of this display panel structure be reduced, but also may the breaking problem, of glass layer existing in filter, caused by the gap generated between the filter 140 and the plasma display panel 110 according to prior plasma TV be avoided under the premise that there is no influence upon the support and enforcement of the filter 140. The invention not only directly forms filter 140 upon the glass 120, but also removes the glass layer originally arranged in filter.

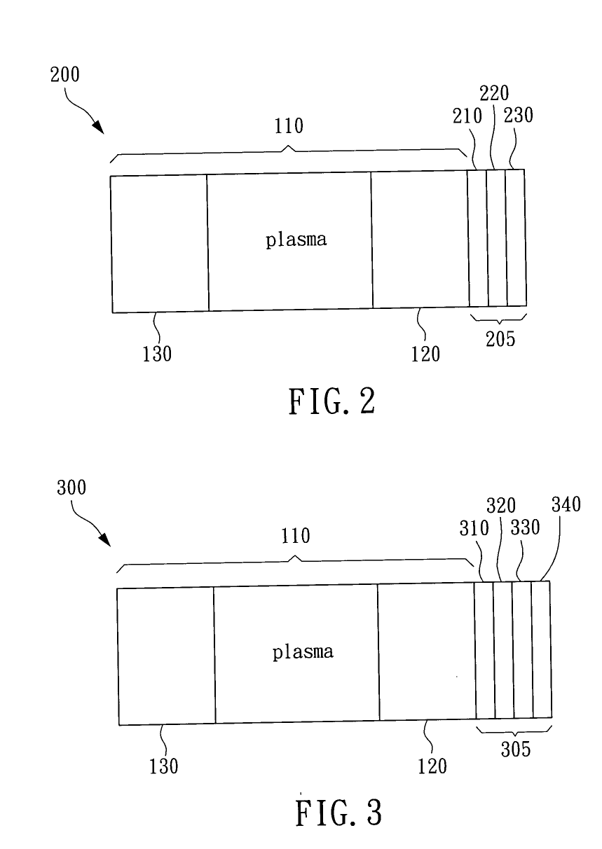

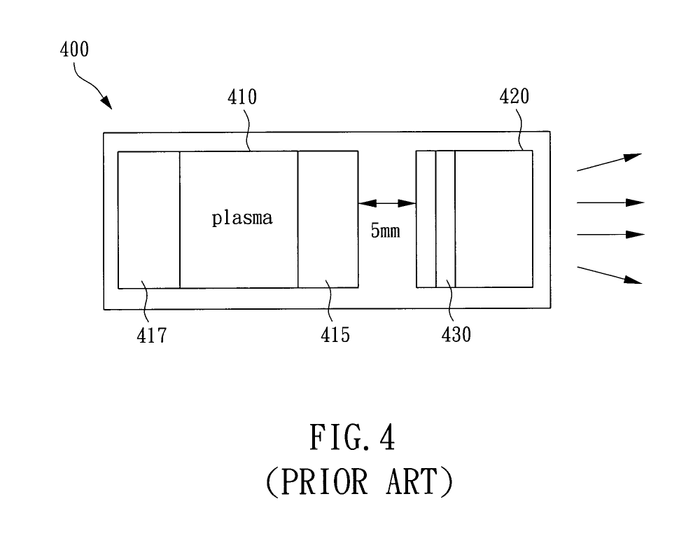

Please refer to FIG. 2, which shows a simple illustration for a side cross-sectional view of the display panel structure of another preferable embodiment according to the present invention. The display panel structure 200 has a plasma display panel 110 shown in FIG. 1 and a filter 205 without containing glass layer. Since this filter 205 does not include glass layer, so this structure of filter 205 facing glass 120 sequentially has electromagnetic wave shielding layer 210, color compensating layer 220, and anti-reflecting layer 230. Except for directly forming filter 205 upon the plasma display panel 110, this display panel structure 200 further removes glass layer from filter 205, so this display panel structure 200 not only makes plasma thinner and lighter, but also lowers down the manufacturing cost of plasma TV to increase its added value.

If worrying the strength of this filter 205 not strong enough to be supported upon the glass 120 of plasma display panel, then a hardening arrangement layer may be added in the filter 205 at adhering place of two layers, such that the filter 205 is enforced. Please refer to FIG. 3, which shows a simple illustration for a side cross-sectional view of the display panel structure of further another preferable embodiment according to the present invention. In this preferable embodiment shown in FIG. 3, the display panel structure 300 includes a plasma display panel 110 same as that shown in FIG. 1 and a filter 305 added a hardening arrangement layer 330 therein. In this filter 305, there is a hardening arrangement layer 330 added at the adhering place between color compensating layer 320 and anti-reflecting layer 330. Therefore, in this preferable embodiment according to the invention, the structure of filter 305 facing glass 120 sequentially has electromagnetic wave shielding layer 310, color compensating layer 320, hardening arrangement layer 330, and anti-reflecting layer 340. Therefore, the filter 305 in this display panel structure 300 is enforced because of the existence of this hardening arrangement layer 330.

In summary, the invention provides a display panel structure that is really a plasma display panel having a function of optical filter, wherein filter is directly formed upon the plasma display panel, such that the glass layer in filter is removed. Therefore, when this display panel structure is applied in plasma TV, not only may the plasma TV be thinner, lighter, and cheaper because of lowered down manufacturing cost and increased added-value, but also a safety consideration is further included.

However, aforementioned description is only preferable embodiment according to the present invention and is not any limitation constrained upon the scope of the invention. Any equivalent variation and modification made according to the claims of the invention are still not departed from the merits of the invention, and are also within the spirit and scope of the invention, so they are all regarded as further executable situations of the invention.

What is claimed is:

1. A display panel structure, comprising:
a plasma display panel, further comprising:
a front glass, through which the plasma display panel display images to the outside;
a rear glass, which is corresponding to the front glass, and there is a plasma spaced between the rear glass and front glass; and
a filter, which is directly formed upon the front glass.

2. The display panel structure according to claim 1, wherein the filter does not include a glass layer.

3. The display panel structure according to claim 2, wherein the filter includes an electromagnetic wave shielding layer, a color compensating layer, and an anti-reflecting layer.

4. The display panel structure according to claim 3, wherein the filter further includes a hardening arrangement layer.

5. The display panel structure according to claim 4, wherein the hardening arrangement layer is arranged at pasting place of two layers of filter.

6. The display panel structure according to claim 5, wherein the filter, facing the front glass, sequentially has electromagnetic wave shielding layer, color compensating layer, hardening arrangement layer, and anti-reflecting layer.

7. A plasma TV, which has a display panel structure, comprising:
a plasma display panel;
a front glass, through which the plasma display panel display images to the outside;
a rear glass, which is corresponding to the front glass, and there is a plasma spaced between the rear glass and front glass; and
a filter, which is directly formed upon the front glass.

8. The plasma TV according to claim 7, wherein the filter does not include a glass layer.

9. The plasma TV according to claim 8, wherein the filter includes an electromagnetic wave shielding layer, a color compensating layer, and an anti-reflecting layer.

10. The plasma TV according to claim 9, wherein the filter further includes a hardening arrangement layer.

11. The plasma TV according to claim 10, wherein the hardening arrangement layer is arranged at pasting place of two layers of filter.

12. The plasma according to claim 11, wherein the filter, facing the front glass, sequentially has electromagnetic wave shielding layer, color compensating layer, hardening arrangement layer, and anti-reflecting layer.
